(19) United States
(12) Patent Application Publication
(10) Pub. No.: US 2009/0069496 A1
(43) Pub. Date: Mar. 12, 2009

(54) COHERENT GEL COATING FOR PREVENTING AND/OR EXTINGUISHING FIRES

(76) Inventor: EDWIN T. SORTWELL, St. Simons Island, GA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 12/197,633

(22) Filed: Aug. 25, 2008

Related U.S. Application Data
(60) Provisional application No. 60/970,419, filed on Sep. 6, 2007.

(51) Int. Cl. C08L 39/00

(52) U.S. Cl. 524/555

(57) ABSTRACT

A method for applying water-laden polymer to a surface to prevent and/or extinguish a fire, the method comprising the steps of dispersing a dry, ground, superabsorbent polymer comprising particles of 20 microns or less in diameter to water in an amount sufficient to form a coherent polymer gel, and directing the coherent polymer gel onto a surface to prevent and/or extinguish a fire.

### CROSS-REFERENCE TO RELATED APPLICATION

The priority benefit under 35 USC 119(e) of U.S. Provisional Patent Application Ser. No. 60/970,419 filed Sep. 6, 2007, is claimed.

### BACKGROUND OF THE DISCLOSURE

1. Field of the Disclosure

The disclosure relates generally to methods for preventing and/or extinguishing fires and, more specifically, to methods for applying water-laden polymer to a surface to prevent and/or extinguish fires.

2. Brief Description of Related Technology

Water is commonly used to extinguish fires and to prevent the spread thereof to nearby structures. Water has several beneficial effects when applied to a fire, including heat removal and oxygen deprivation. When water is directed at a structure adjacent a fire to prevent its spread thereto, the fire must provide enough heat to evaporate the water on (or in the materials of) the adjacent structure before the adjacent structure can reach its combustion or ignition temperature.

One disadvantage to using water to prevent a fire from spreading to a nearby structure is that most of the water directed at the structure does not soak into the structure to provide fire protection, but rather tends to run off the structure to the ground. Consequently, a significant quantity of water is wasted. Another disadvantage is that any water that does soak into the structure provides only limited protection against the fire because most structures only absorb a limited amount of water, and that limited amount of absorbed water quickly evaporates. Therefore, significant manpower must be expended to continuously reapply water on nearby structures to provide them with continuing fire protection.

A disadvantage to using water to extinguish fires is that a considerable amount of the water does not directly fight or extinguish the fire because of the run-off problem described above. Another disadvantage to using water in extinguishing fires is that the water sprayed directly on the fire evaporates at an upper level of the fire, with the result that significantly less water than is applied is able to penetrate sufficiently to extinguish the base of the fire.

There are a number of US patents that address the use of particulate superabsorbent dry polymers for use in fire prevention and fire extinguishing, including: von Blücher U.S. Pat. No. 4,978,460; von Blücher U.S. Pat. No. 5,190,110; and Pascente U.S. Pat. No. 5,849,210. An understanding of the properties of these polymers and how they can be used to improve fire prevention and fire extinguishing is useful.

Superabsorbent polymers were developed from of a generic class of water-soluble synthetic polymers that are primarily used in water clarification. These synthetic polymers have a tremendous affinity for water and they dissolve in water, forming ‘fish nets’ of entangled linear molecules, with molecular weights in the millions, that act to agglomerate and precipitate unwanted solids from water. These water-soluble polymers are generally available in dry, particulate form and are dissolved in water over time to produce a functional solution. Time of dissolution is not generally a serious concern. A solution is produced as each successive molecular layer from the surface of the polymer particle is dissolved. Thus, the size of the particle determines only the time for dissolution. While this process may seem obvious, understanding the sequential, surface-in nature of polymer dissolution is a fundamental factor in effective use of particulate superabsorbent polymers in fire fighting.

Superabsorbent polymers are produced by adding to a reaction mixture of the linear polymers described above, cross-linking agents which form two- and/or three-dimensional bonds between the linear molecules. The effect of this cross-linking is to immobilize the linear molecules. Their affinity for water is not reduced, but now water must be absorbed within the cross-linked structure. The particulate structure does not change in shape as it absorbs water, but simply swells, retaining its relative dimensional configuration. The ultimate size of the hydrated superabsorbent polymer particle is a function of its size in the dry state. The rate of water absorption of the surface superabsorbent particle is the same as for the surface of the linear particle mentioned above, but because the surface layer does not dissolve and move away from the particle's surface, the rate of water penetration of the cross-linked polymer is much slower than the rate of dissolution of linear polymer. As a result, the rate of water uptake by the superabsorbent polymer is affected by particle size impeded by the cross-linked structure.

Superabsorbent polymers in the fire-fighting world are referred to as “water enhancers.” The polymer itself does virtually nothing to prevent or extinguish combustion, but rather immobilizes water that would otherwise either evaporate or run off the combustion surface, in either case becoming ineffective in preventing or extinguishing a fire. It is at this point that the rate at which a superabsorbent polymer takes up water, and the structural sizes of polymer particles after uptake of water, become critical in firefighting effectiveness. In immobilizing water, it is critical that the superabsorbent polymer take up water quickly and uniformly so that a homogenous, cohesive gel is formed. In order to provide the greatest combustion surface protection it is essential that the gel produced utilizes the available water, provides an absolutely uniform coating (like paint) on the surface to which it is applied, and that such uniformity of gel builds a structure that allows development of a coating of sufficient viscosity to, at one end of the viscosity spectrum, flow around and coat needles, twigs and branches on trees, and when concentrated, to adhere in thickness to vertical surfaces for structure protection. Gels that contain discrete, water-swollen particles that interrupt uniform film formation are not optimally functional in fire fighting and do not form films that will provide uniform coatings on vertical surfaces.

A critical issue in producing a truly film-forming coating is definition and control of the original particle size of the dry superabsorbent polymer particle before hydration. Only by such control can the optimal uniform cohesive gel structure be produced. Without control of particle size, discontinuous partial coatings are produced that leave areas of thin or no coating, the swollen gel agglomerates having no film of gel protecting the area between the agglomerates. The swollen gel agglomerates are essentially surrounded by plain water that simply runs off or evaporates, making it impossible to build a gel structure that will film, or adhere to a vertical, or even sloped surface. Individual swollen gel particles simply fall off. Even on horizontal surfaces, where the swollen gel particles don't fall off, the discontinuous, film-free areas between swollen gel particles are analogous to weak links in the fire-fighting chain, the film-free area being essentially unprotected from combustion.

The teachings of the three US patents identified above do not recognize the significant parameter of particle size in production of a cohesive coating. von Blücher '460 specifically describes the water-added product as having a bulk viscosity “only slightly higher than water,” meaning that the larger particles of swollen superabsorbent polymer (exemplified as having a dry particle size of 100 to 300 microns) would, by definition, be essentially floating in, or surrounded by water. This would not produce a homogenous, cohesive coating to significantly prevent or extinguish combustion, and the comparative test results in '460 bear this out. Further, a composition containing water and swollen, superabsorbent particles does not adhere to vertical surfaces. There is nothing inherently sticky about swollen superabsorbent particles, particularly when they are surrounded by water and they move easily from place to place. The modest increase in time of combustion protection detailed in '460 is undoubtedly due to the water contained in the swollen gel particles providing some minimal additional water in the vicinity of combustion but this does not compare with the protection provided by a continuous, cohesive gel coating.

The teachings of '460 are concerned with preventing lumping of particles of superabsorbent polymer that “was impossible to grind” (column 4, line 15). Superabsorbent polymers can be finely ground utilizing the proper equipment. Finely ground superabsorbent polymer does not require silicic acid or other additives to accelerate its swelling or water take up, as it takes up water just as quickly in its pristine, finely ground state. The teachings of ‘460’ relating to encapsulating superabsorbent polymer particles in a water soluble release agent (in a high percentage in an example), are unnecessary to assure lump-free water absorption.

von Blücher '110 teaches directly away from the production of a uniform gel film, specifically teaching that the viscosity of the admixture of superabsorbent polymer and water should have a viscosity of less than 100 cps. Such a viscosity is consistent with swollen lumps of gel surrounded by essentially water-viscosity water. This, not surprisingly, produces a mixture as easily handled as water but it does not produce a uniform coating on any surface to prevent surface combustion. The best way to prevent the low viscosity water from running off and being wasted is to thicken it with finely ground superabsorbent polymer and have all the superabsorbent product utilized in producing a uniform gel having a viscosity of more than 100 cps. The firefighter does not want water running anywhere, he wants it to stay where it is directed. Immobilizing all the water within an homogenous, cohesive gel structure accomplishes that objective.

Pascente '210 teaches substantially the same firefighting ability of water-swollen gel as the earlier '460 and '110, and does not address the particle size of the dry superabsorbent polymer. Although it is taught that superabsorbent polymer particles should have a particle size “preferably less than 100 μm in diameter” (column 4, line 17), the stated reason for this limitation is so the gel produced can be extruded through the nozzle of a fire extinguisher. This teaching recognizes that swollen gel particles are of such significant size that they need to be deformed to pass through the relatively large openings of a fire nozzle. Further, there is recognition of the non-uniformity and non-film-forming nature of the water/superabsorbent polymer mixture beginning in column 6, line 26, where it's stated that “higher viscosity gels can be adhesively secured to vertical or sloped surfaces to hold the gel in place.” A non-homogenous mixture of swollen polymer particles in water will not adhere by itself to a vertical surface, hence the need for an “adhesive.” Polymer particle sizing loosely described as less than 100 μm (100 microns) does not meet criteria for producing an homogenous, cohesive uniform coating that will adhere by itself to a vertical surface. A commercial dry superabsorbent firefighting product available in the United States demonstrates the deficiency of large particle sizes for forming coherent, homogenous coatings for preventing or extinguishing fire.

### SUMMARY OF THE DISCLOSURE

This disclosure demonstrates the significant improvement in fire prevention and/or extinguishing of a coherent, aqueous gel produced from dry, superabsorbent polymer particles ground to substantially 20 microns or less in diameter when compared to firefighting gels produced from larger particles that do not produce coherent coatings. Preferably, the mean particle diameter of the dry polymer is less than 20 microns, highly preferably 10 microns or less, and most preferably less than 10 microns. If the superabsorbent polymer particles of less than 20 microns are dispersed directly in water, they will produce anything from a smooth, film-forming coating at low concentration to a thick gel that will build a self-adherent coating at higher concentrations up a half-inch thick or more on a vertical surface without the need for any adhesive. Both the low concentration uniform film and higher concentration thick gel coating provide far better fire protection that an admixture of the same respective concentrations produced from coarser superabsorbent polymer particles. The coherent gels significantly retard combustion and, further, the coherent gel can be sprayed onto vertical and other burning surfaces to extinguish fire. The superabsorbent polymers of this disclosure preferably produce gels that hold more than 50% of the water in the water-additive mixture after swelling.

### DETAILED DESCRIPTION

The preferred superabsorbent polymer of this disclosure is preferably a dry, cross-linked, water-soluble polymer, most preferably produced from at least one of the following monomers.

The polymer is preferably a polymer of hydrophilic monomers, such as acrylamide, acrylic acid derivatives, maleic acid anhydride, itaconic acid, 2-hydroxyl ethyl acrylate, polyethylene glycol dimethacrylate, allyl methacrylate, tetraethyleneglycol dimethacrylate, triethyleneglycol dimethacrylate, diethylene glycol dimethacrylate, glycerol dimethacrylate, hydroxypropyl methacrylate, 2-hydroxyethyl methacrylate, 2-tert-butyl amino ethyl methacrylate; dimethylaminopropyl methacrylamide, 2-dimethylaminoethyl methacrylate, hydroxypropyl acrylate, trimethylolpropane trimethacrylate, 2-acrylamido-2 methylpropanesulfonic acid derivatives, and other hydrophilic monomers. Preferably, the polymer is a co-polymer of acrylamide and acrylic acid derivatives and, more preferably, a terpolymer of an acrylate salt, acrylamide, and a 2-acrylamido-2-methylpropanesulfonic acid (AMPS) salt. The salts may generally be any monovalent salt, but preferably are sodium, potassium, or ammonium salts.

Many such dry polymers are commercially available and are routinely used in diapers, and as soil amendments in agriculture.

Because the degree of hardness of the water, in other words the amount of divalent cations in the water, affects the degree of swelling of the polymer particles, a component may also be introduced to counteract water hardness. A suitable monomer to counteract water hardness in this application is 2-acrylamido-2-methylpropane sulfonic acid (AMPS) or a salt or other derivative thereof. The polymer is preferably a terpolymer of an acrylate salt, acrylamide, and an AMPS salt. The amount of AMPS included in the dry polymer may be varied depending on the hardness of the water in the particular region of use. Nevertheless, the polymer is effective without inclusion of a chemical to counteract water hardness, particularly in geographical regions that do not have hard water. Depending on the hardness of water, higher concentrations of polymer (e.g., up 2 wt. % of dry polymer in waters of very high hardness) may prove useful in forming the coherent gel for use in the invention.

To illustrate the invention, a relatively finely ground, commercially available superabsorbent polymer (AQUASORB 3005-KC made by SNF, Inc.) was further commercially ground on a jet mill manufactured by Netzsch Inc., without difficulty, to a particle size of 97% less than 20 microns/100% less than 30 microns and a mean value of 9.2 microns.

After grinding, the ground polymer of mean value 9.2 microns was mechanically dispersed in water to determine the quality of gel produced at concentrations from 0.3 wt. % to 1.0 wt. % dry polymer solids. No discrete particles in the gels could be detected at any concentration. The coherent gels produced coatings from a thin, almost imperceptible layer (at 0.3 wt. % dry polymer solids) when applied to a smooth surface, through a flowable gel that produced coherent coatings on sloped or vertical surfaces of ⅛ to 3/16 of an inch thick (at 0.5 wt. % dry polymer solids), to a homogenous coherent gel that would adhere to a vertical surface in thicknesses of up to ¾ inch (at 1.0 wt. % dry polymer solids).

For comparative purposes, the same relatively finely-ground, commercially available superabsorbent polymer described above was commercially ground to a coarser specification (99.0% minus 150 microns, 97% minus 75 microns, 91.1% minus 38 microns, 83.8% minus 25 microns). This grind did not produce a coherent coating at 0.5 wt. % dry polymer solids, and the viscosity of the 0.5 wt. % dispersion was barely higher than water viscosity. Particles were visually apparent in the 0.5 wt. % dispersion. This clearly demonstrates the need for fine particle size in order to produce functional coherent coatings.

One undesirable and market-limiting characteristic of the finely ground 9.2 micron mean particle size superabsorbent polymer was severe dusting on handling. The dusting problem would probably have made using the finely ground polymer impractical. However, dusting can be controlled by the addition of an anti-dusting agent such as fumed silica, preferably in an amount of 3 wt. % to 7 wt. % based on the weight of dry ground polymer. The addition of fumed silica (CAB-O-SIL EH-5) did not inhibit the rapid formation of gel when the polymer was mechanically dispersed in water, nor did it have any deleterious effect on the quality or firefighting ability of the gel at any concentration. The various concentrations of the finely-ground, silica-treated superabsorbent polymer of this disclosure were compared to the rate of gel formation, visual quality, film forming ability, coherence, adherence to a vertical surface and firefighting performance of the commercially available product mentioned above.

Comparing the polymer product of this disclosure with that of the commercially available superabsorbent firefighting polymer (PHOS-CHEK AQUAGEL K) at concentrations in water of 0.3 wt. %, 0.5 wt. %, 0.75 wt. %, and 1.0 wt. %, at all concentrations the finely ground polymer product of this disclosure dispersed to a coherent homogenous gel virtually instantly. This coherent gel coated and adhered to vertical surfaces in increasing thickness as the concentration was increased. In all cases the commercially available product produced granular dispersions that did not produce a coherent coating nor adhere to vertical surfaces. These comparisons were made by dipping wooden boards vertically into each product at the four concentrations and then removing the boards and observing coating characteristics. Comparative viscosities of the product of this disclosure and the commercially available firefighting gel are given in Table 1:

TABLE 1
Viscosities In cps; Brookfield LVT Viscometer
[TDS is Total Dissolved Solids; Hardness as Calcium Carbonate]

| | Product of disclosure | | | | Commercially available | |
|---|---|---|---|---|---|---|
| | (5 wt. % silica-treated) | | | | product | |
| | (concentrations in water) | | | | (concentrations in water) | |
| Water-type | 0.3 wt. % | 0.35 wt. % | 0.4 wt. % | 0.5 wt. % | 0.3 wt. % | 0.5 wt. % |
| TDS 270 ppm | 490 cps | | | 6400 cps | 20 cps | 600 cps |
| (no | | | | | | |
| hardness) | | | | | | |
| TDS 270 ppm | | 900 cps | 1950 cps | 4700 cps | | 600 cps |
| (hardness | | | | | | |
| 110 ppm) | | | | | | |
| TDS 260 ppm | | | | 3650 cps | | 350 cps |
| (hardness | | | | | | |
| 220 ppm) | | | | | | |

The viscosity comparisons show clearly the differences in characteristics of the two products in water. The Brookfield viscometer's rotating sensing element responds normally to the increasing coherent concentrations of the product of this disclosure. True viscosity measurements are only scientifically meaningful in homogenous substrates and, in the case of the commercially available product, the sensing element is essentially just spinning in the water between the swollen gel particles, with the swollen gel particles bouncing off the element and providing some frictional resistance.

Viscosities are given for various waters. The 270 ppm TDS/110 ppm total hardness water represents an average naturally-occurring water. The viscosities at additional concentrations are shown to demonstrate how easily a desired viscosity can be achieved with gel produced from the product of this disclosure. Gel viscosities in the range of 800 cps to 1400 cps would generally be used in aerial firefighting, depending on the type of trees and/or underbrush (fuels) to be coated and the thickness of coherent gel coating desired.

The same dipped sample boards described above, standing vertically, were then exposed to a propane impingement flame. The comparative times for the impinging flame to burn through the dipped coatings and ignite the boards are given in Table 2:

TABLE 2

| | Product of this | |
|---|---|---|
| | disclosure | Commercially available |
| Aqueous Gel | (time to ignite | product |
| Concentration | the board) | (time to ignite the board) |
| wt. % | seconds | seconds |
| 0.3% | 22 | 3 |
| 0.5% | 31 | 4 |
| 0.75% | 51 | 4 |
| 1.0% | 82 | 4 |

The homogenous coherent gel coatings of this disclosure give spectacular fire protection.

When a uniform coating is not formed by the superabsorbent polymer in water (as is the case with the commercially available product), there is virtually no improvement in the fire-protecting properties of the gel over plain water. This is not really surprising since there is only a water-wet surface between the swollen gel particles. The impinging flame simply evaporates that surface water and ignites the wood. The water-wet surface between the swollen gel particles of the commercially available product is the weak link in the firefighting chain.

Interestingly, if the 0.75 wt. % gels of both products as described in Table 2 are applied onto a horizontal wood surface to ⅜^{th} of an inch thickness, a completely different result is obtained. The gel product of the present disclosure burns through in 77 seconds; the commercially available gel product burns through in 64 seconds, which tends to confirm results of Pascente '210, where gel was spread on the horizontal surfaces of burning charcoal (column 6, lines 17-20). But the only way the '210 results could be simulated was through the careful packing of the swollen gel particles to form the ⅜ inch layer, and carefully keeping the board horizontal so the particles didn't slide off. The product of the present disclosure can be sprayed, or dropped from aircraft, to form a coating that will adhere, but the product described in '210 can't, since it won't adhere to a horizontal surface, or to itself. The suggestion in '210, that an adhesive be first applied, say to a forest to induce adhesion of the gel, is impractical at best. The key is forming a coherent gel coating that will adhere by itself.

To simulate aerial drop applications for fighting forest fires from either fixed-wing aircraft or helicopters, a series of wooden dowels of ⅛^{th} inch, 3/16^{th} inch, and ¼ inch in diameter were mounted vertically, spaced ⅛^{th} inch to 3/16^{th} inch apart. The dowels ranged in length from 10 inches to 12 inches.

The first test was to spray 0.5 wt. % concentrations of the product of this disclosure, and the commercially available product, on the dry dowels from above to simulate aerial application and evaluate the products as fire retardants (i.e., where aerial drops are made ahead of the fire front, as a fire break, with the intent to stop the fire at that point). The coherent gel of this disclosure was easily sprayed from above, but the gel dispersion of the commercially available product plugged the spray nozzle and finally had to be poured over the vertical dowels in order to get acceptable distribution. After application of the two gels, visual observation showed the coherent gel of this disclosure to have thoroughly coated each vertical dowel with a uniform film. The gel made from the commercial product wetted the dowels, with a few gel particles jammed between the dowels, but there was no functional coating. Fifteen minutes after each of these respective applications, propane flame was applied near the base of the dowels, circling the dowel grouping continuously with the flame from a fixed distance. The dowel grouping, to which the commercially available gel was applied, was totally engulfed in self-sustaining flame in 21 seconds. The dowel grouping, to which the gel of this disclosure was applied, did not sustain combustion at any point on any individual dowel for 65 seconds, and the grouping was totally engulfed in self-sustaining flame only after 118 seconds. Spraying plain water, and repeating this test, resulted in self-sustaining combustion in 18 seconds. Application of the gel, that is subject of this disclosure, clearly gave superior fire retarding performance when compared to gel from the commercially available product.

The final test was to confirm the fire extinguishing ability of gels vs. water. A dowel grouping was ignited and combustion allowed to proceed until flames towered about 18 inches above the dowels. Water was sprayed from eighteen inches above the flame top in a fixed time period without significant effect, the flames momentarily dying down and then surging until all the dowels were burned to their bases. Repeating the test, the same volume of 0.5 wt. % gel made from the subject of this disclosure was sprayed in the same time period from the same distance above the approximately 18 inch high flames. Flame was completely extinguished.

It was not possible to test gel made from the commercially available product under the same conditions. Gel made from the commercially available product could not be sprayed because the gel lumps caused plugging. When the same volume of gel made from the commercially available product was poured over the same flame height, part of the dowel grouping was briefly extinguished but shortly thereafter the still burning dowels re-ignited those that had been extinguished, and all the dowels burned to their bases.

The coherent gel coating, the subject of this disclosure, quickly extinguished this simulation of a ‘crowning’ forest fire, and did not allow re-ignition. (A ‘crowning’ fire is where the flame front spreads quickly from tree-top to tree-top.) Non-homogenous gel, made from commercially available product, was comparatively deficient in extinguishing the simulated crowning fire.

The coherent gel coating, the subject of this disclosure, is clearly superior in preventing and extinguishing fire when compared to a non-uniform gel coating.

1. A method for applying water-laden polymer to a surface to prevent and/or extinguish a fire, the method comprising the steps of:
(a) dispersing a dry, ground, superabsorbent polymer comprising particles of 20 microns or less in diameter to water in an amount sufficient to form a coherent polymer gel; and,
(b) directing the coherent polymer gel onto a surface to prevent and/or extinguish a fire.

2. The method of claim 1 wherein the superabsorbent polymer comprises particles of less than 20 microns in diameter.

3. The method of claim 1, wherein the polymer is mixed with at least one anti-dusting agent before being dispersed in water.

4. The method of claim 3, wherein the anti-dusting agent is fumed silica.

5. The method of claim 4, wherein the fumed silica is present in an amount equal to 3 wt. % to 7 wt. % based on the weight of the dry polymer.

6. The method of claim 1, wherein the polymer holds more than about 50 wt. % of the water in the gel after swelling.

7. The method of claim 1, wherein the mean diameter of the dry polymer particles is 10 microns or less.

8. The method of claim 1, wherein the mean diameter of the dry polymer particles is less than 10 microns.

9. The method of claim 1, wherein the dry polymer consists essentially of particles with diameters of 20 microns or less.

10. The method of claim 9, wherein the mean diameter of the dry polymer particles is 10 microns or less.

11. The method of claim 1, wherein the dry polymer consists essentially of particles with diameters of less than 20 microns.

12. The method of claim 11, wherein the mean diameter of the dry polymer particles is less than 10 microns.

13. The method of claim 1, wherein the polymer is formed from a hydrophilic monomer selected from the group consisting of acrylamides and acrylic acid derivatives.

14. The method of claim 13, wherein the acrylic acid derivative is an acrylate salt.

15. The method of claim 1, wherein the polymer is a terpolymer of an acrylate salt, acrylamide, and a 2-acrylamido-2-methylpropanesulfonic acid salt.

16. The method of claim 1, wherein a concentration of the polymer in water is in the range of up to 2 wt. %.

17. The method of claim 1, wherein the concentration of the polymer in water in the range up to 1.0 wt. %.

18. The method of claim 17, wherein the concentration of the polymer in water is at least 0.3 wt. %.
